(19) United States
(12) Patent Application Publication
(10) Pub. No.: US 2026/0291358 A1
(43) Pub. Date: Sep. 24, 2026

(54) COOLING SYSTEM FOR ELECTROMAGNETIC PUMP SYSTEM

(71) Applicant: Nano Nuclear Energy Inc., New York, NY (US)

(72) Inventor: Carlos Omar Maidana, Pocatello, ID (US)

(21) Appl. No.: 19/030,068

(22) Filed: Jan. 17, 2025

Related U.S. Application Data
(60) Provisional application No. 63/671,286, filed on Jul. 15, 2024.

(51) Int. Cl. H02K 44/04; G21C 15/247; H02K 9/00

(52) U.S. Cl. CPC H02K 44/04; H02K 9/00; G21C 15/247

(57) ABSTRACT

An electromagnetic pump system for moving conducting fluid, and a cooling system for an electromagnetic pump system is provided. In some aspects, the cooling system includes a cooling stack comprising a plurality of cooling units arranged in sequence, and configured to cool a plurality of coil units of the electromagnetic pump system. A cooling unit includes a first cooling plate that comprises a cooling unit input, a second cooling plate that is parallel to the first cooling plate, and comprises a cooling unit output, at least one connector plate connecting the first cooling plate and the second cooling plate, and a network of microchannels formed in the first cooling plate, the second cooling plate, and the at least one connector plate, the network of microchannels connecting the cooling unit input and the cooling unit output, and allowing a cooling fluid to flow therethrough.

### CROSS-REFERENCE TO RELATED APPLICATIONS

The present application is based on and claims the benefit of U.S. Provisional Application No. 63/671,286 filed on Jul. 15, 2024, and titled “Micro-Channel Cooling System for Electromagnetic Pumps,” which is incorporated herein by reference in its entirety.

### STATEMENT REGARDING FEDERALLY SPONSORED RESEARCH AND DEVELOPMENT

This invention was made with government support under SBIR Grant Nos. DE-SC0019835, DE-SC0022805, and DE-SC0013992 awarded by U.S. Department of Energy. The government has certain rights in the invention.

### TECHNICAL FIELD

This disclosure relates generally to fluid control technologies, and more particularly, to an electromagnetic pump system for moving conducting fluid, and a cooling system for an electromagnetic pump system.

### BACKGROUND

A Molten Salt Reactor (MSR) is a type of nuclear reactor that produces heat, which can be used in electricity generation, high-temperature process heat, and other applications. Unlike traditional nuclear reactor technologies, an MSR utilizes a molten salt mixture as both coolant and fuel, with most of its volume residing in the reactor core. Molten salt can provide efficient heat removal from a reactor's core, reducing piping requirements, and decreasing overall core dimensions due to reduced component size. While operating at high temperatures and low pressures, an MSR can be efficient at generating energy, and can enhance safety by reducing risk of large breaks and loss of coolant. In addition, an MSR can generate less waste because it does not require solid fuel and infrastructure for disposing spent fuel. Furthermore, an MSR can adapt to a variety of nuclear fuel cycles (such as Uranium-Plutonium and Thorium-Uranium cycles), which can extend fuel resources. For instance, an MSR can be designed as nuclear waste “burners” or breeders.

A liquid metal-cooled reactor, such as a fast neutron reactor, is another type of nuclear reactor that is both moderated and cooled by a liquid metal solution. With a compact footprint, a liquid metal-cooled reactor can be used for electric power generation in isolated places, for fission surface power units for planetary exploration, for naval propulsion, and as part of space nuclear propulsion systems. A liquid metal-cooled reactor may be desirable for space, as well as other applications in which transportability, weight, reliability, efficiency, working environment, and so forth, are a factor.

While water could be theoretically used for reactor cooling, in practice, water has a low boiling point, and tends to slow down and absorb neutrons. This limits the amount of water that can flow through a reactor core, and any water-based cooling system would need to be operated at high pressure to provide effective cooling. Therefore, liquid metal or molten metal is typically utilized for heat removal and transport.

While molten salt and liquid-metal can provide some benefits to reactor cooling, they present technical challenges. For instance, traditional pumps for circulating liquid metal include mechanical radial or axial pump designs. However, liquid metal can be very corrosive to these traditional pumps, and cause significant damage to pump impeller, bearings, seals, and so forth. Also, traditional pumps can suffer from significant cavitation, which can cause unwanted damage, vibration, energy consumption, and reduced lifespan. Similarly, molten salt can also be highly corrosive, and corrosivity increases with temperature.

Therefore, there is a need for improved cooling and fluid control technologies.

### SUMMARY

According to some implementations of the present disclosure, a cooling system for an electromagnetic pump system is provided. In some aspects, the cooling system includes a cooling stack comprising a plurality of cooling units arranged in sequence, and configured to cool a plurality of coil units of the electromagnetic pump system. A cooling unit includes a first cooling plate that comprises a cooling unit input, a second cooling plate that is parallel to the first cooling plate, and comprises a cooling unit output, at least one connector plate connecting the first cooling plate and the second cooling plate, and a network of microchannels formed in the first cooling plate, the second cooling plate, and the at least one connector plate, the network of microchannels connecting the cooling unit input and the cooling unit output, and allowing a cooling fluid to flow therethrough.

According to some implementations of the present disclosure, an electromagnetic pump system is provided. The electromagnetic pump system includes an electromagnetic pump including a hollow duct extending from a first duct end to a second duct end, the hollow duct having an inlet portion, a central portion, and an outlet portion, and a core positioned inside the hollow duct that extends from a first core end to a second core end, wherein the hollow duct and the core form an annular channel for carrying a conducting fluid. The electromagnetic pump also includes a coil assembly comprising a plurality of coil units, and stator assembly comprising a plurality of stator units arranged about the hollow duct, the stator assembly configured to receive the plurality of coil units. The electromagnetic pump further includes a cooling system comprising at least one cooling stack with plurality of cooling units arranged in sequence, the at least one cooling stack arranged about the plurality of coil units and configured to cool the plurality of coil units.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The foregoing and other advantages of the present disclosure will become apparent upon reading the following detailed description and upon reference to the drawings.

FIG. 1A is perspective illustration of an electromagnetic pump, according to aspects of the present disclosure;

FIG. 1B is another perspective illustration of the electromagnetic pump in FIG. 1A, according to aspects of the present disclosure;

FIG. 1C is a front view of the electromagnetic pump in FIG. 1A, according to aspects of the present disclosure;

FIG. 1D is a cross-sectional view of the electromagnetic pump in FIG. 1A, according to aspects of the present disclosure;

FIG. 2A is a perspective illustration of an example hollow duct for the electromagnetic pump in FIG. 1A, according to aspects of the present disclosure;

FIG. 2B is another perspective illustration of the hollow duct in FIG. 2A having a plurality of coil units installed thereon, according to aspects of the present disclosure;

FIG. 3A is a perspective illustration of an example core for the electromagnetic pump in FIG. 1A, according to aspects of the present disclosure;

FIG. 3B is a cross-section of the core in FIG. 3A, according to aspects of the present disclosure;

FIG. 3C is a cross-section of a portion of the core in FIG. 3A, according to aspects of the present disclosure;

FIG. 3D is another cross-section of the core in FIG. 3A, according to aspects of the present disclosure;

FIG. 3E is a side view of the core in FIG. 3A, according to aspects of the present disclosure;

FIG. 3F is another side view of the core in FIG. 3A, according to aspects of the present disclosure;

FIG. 4A is a perspective view of an example coil assembly for the electromagnetic pump in FIG. 1A, according to aspects of the present disclosure;

FIG. 4B is a perspective view of a coil unit in coil assembly of FIG. 4A, according to aspects of the present disclosure;

FIG. 4C is a perspective view of the coil unit in FIG. 4C, according to aspects of the present disclosure;

FIG. 4D is an illustration of another example coil unit with a conductive matrix, according to aspects of the present disclosure;

FIG. 5A is a perspective view of an example stator unit for the electromagnetic pump in FIG. 1A, according to aspects of the present disclosure;

FIG. 5B is a cross-section of the stator unit of FIG. 5A, according to aspects of the present disclosure;

FIG. 5C is a side view of the stator unit in FIG. 5A, according to aspects of the present disclosure;

FIG. 6A is a perspective view of an example cooling stack for the electromagnetic pump in FIG. 1A, according to aspects of the present disclosure;

FIG. 6B is an illustration of a cooling unit in the cooling stack of FIG. 6A, according to aspects of the present disclosure;

FIG. 6C is a cross-section of the cooling unit in FIG. 6B, according to aspects of the present disclosure;

FIG. 6D is another cross-section of the cooling unit in FIG. 6B, according to aspects of the present disclosure;

FIG. 6E is another cross-section of the cooling unit in FIG. 6B, according to aspects of the present disclosure;

FIG. 7A is a perspective view of an example cooling sleeve for the electromagnetic pump in FIG. 1A, according to aspects of the present disclosure;

FIG. 7B is another perspective view of the cooling sleeve of FIG. 7B, according to aspects of the present disclosure;

FIG. 8A is an illustration of components of a support structure for the electromagnetic pump of FIG. 1A, according to aspects of the present disclosure;

FIG. 8B is another illustration of components of a support structure for the electromagnetic pump of FIG. 1A, according to aspects of the present disclosure;

FIG. 9 is a schematic diagram of an example electromagnetic pump system, according to aspects of the present disclosure;

FIG. 10 is a flowchart setting forth steps of a process for operating an electromagnetic pump system, according to aspects of the present disclosure.

While the present disclosure is susceptible to various modifications and alternative forms, specific implementations have been shown by way of example in the drawings and will be described in further detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Molten salt and liquid-metal commonly used for reactor cooling can present various technical challenges to conventional pump technologies, including undesirable damage, cavitation, vibration, higher energy consumption, reduced lifespan, and so forth. Also, intense radiation, high operational temperatures, and corrosion associated with molten salt and liquid-metal present difficult conditions for conventional pump technologies.

The present disclosure describes various embodiments of an electromagnetic pump system, and cooling system for an electromagnetic pump system. As appreciated from description herein, the present disclosure introduces an approach that provides a number of advantages over conventional technologies, including predictability, reliability, economies of scale, longevity, reduced maintenance, and so forth.

The present disclosure is described with reference to the attached figures, where like reference numerals are used throughout the figures to designate similar or equivalent elements. The figures are not drawn to scale, and are provided merely to illustrate the instant disclosure. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more of the specific details, or with other methods. In some instances, certain structures or operations are not shown in detail to avoid obscuring the disclosure. The present disclosure is not limited by illustrated ordering of steps, acts or events, as some steps, acts, or events may occur in different orders and/or concurrently with other steps, acts, or events. Furthermore, not all illustrated steps, acts, or events are required to implement an approach described in the present disclosure.

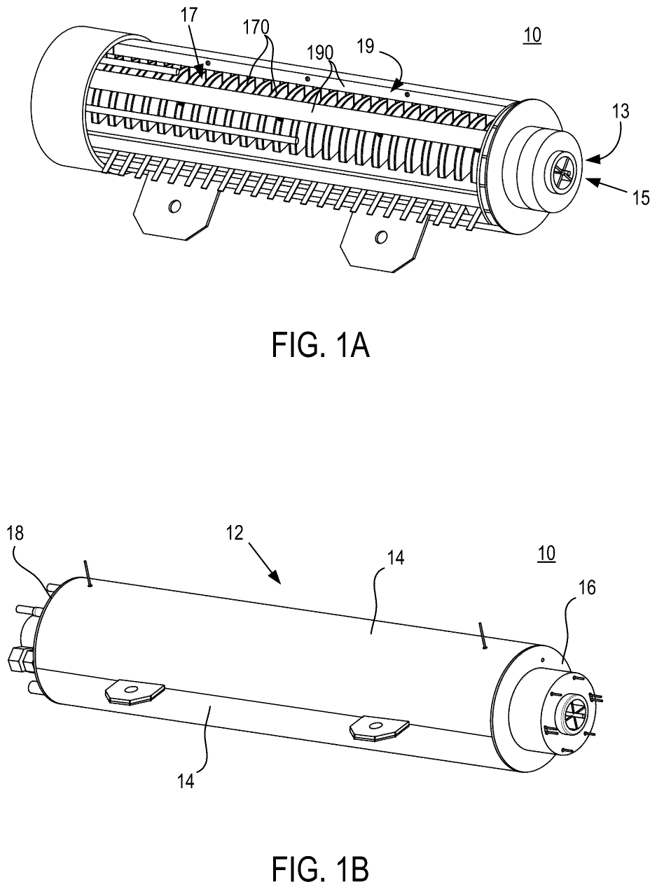

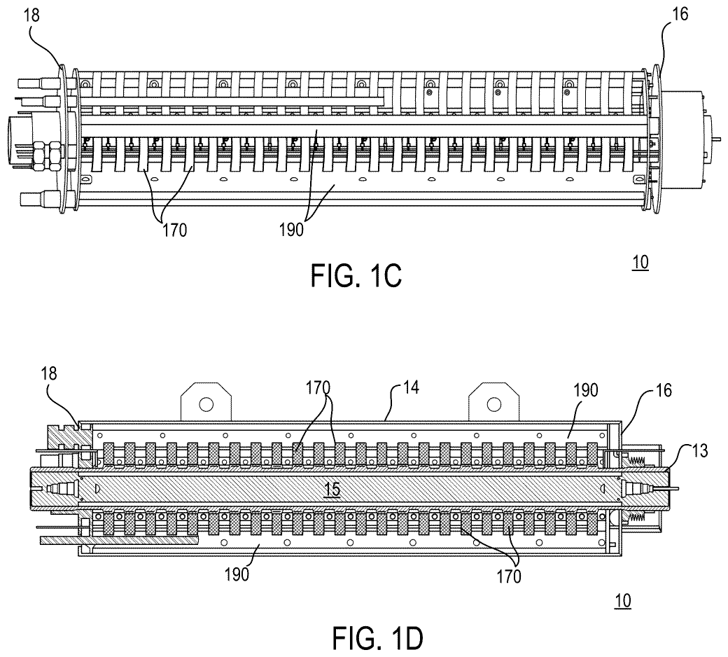

Turning now to FIGS. 1A to 1D, an electromagnetic pump 10 for moving a conductive fluid, in accordance with aspects of the present disclosure, is illustrated. In some non-limiting applications, the electromagnetic pump 10 may be used to control a temperature of a reactor, or reactor core.

Referring specifically to FIG. 1A, the electromagnetic pump 10 may generally include a hollow duct 13, a core 15, a coil assembly 17 that includes a number of coil units 170, and a stator assembly 19 that includes a number of stator units 190. In some embodiments, as shown in FIG. 1B, the electromagnetic pump 10 may include a support system 12 to secure and protect various components of the electromagnetic pump. For instance, in some embodiments, the support system 12 may include an enclosure formed by one or more shell 14, a first end plate 16, a second end plate 18, which when assembled, at least partially encase the hollow duct 13, the core 15, the coil assembly 17, and the stator assembly 19, as illustrated in FIG. 1B.

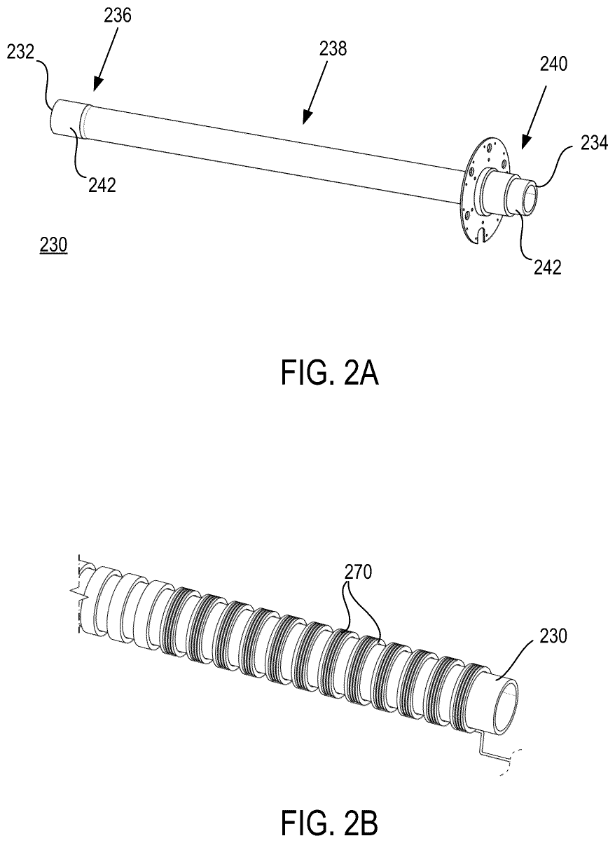

Referring particularly to FIGS. 2A and 2B, one embodiment of a hollow duct 230, in accordance with aspects of the present disclosure, is illustrated. As shown, the hollow duct 230 extends from a first duct end 232 to a second duct end 234, and may include an inlet portion 236, a central portion 238, and an outlet portion 240. In some embodiments, the inlet portion 236, the outlet portion 240, or both, may include an enlarged section 242 with an outer diameter that is larger than the outer diameter of the hollow duct 230 at the central portion 238. The enlarged section 242 may help facilitate installation and/or securing of one or more component thereto, such as a structure plate, as illustrated in FIG. 2A. In some embodiments, the hollow duct 230 may have a number of coil units 270 arranged thereon, as illustrated in FIG. 2B.

A shape, dimension, and/or material used to form the hollow duct 230 may vary. In some applications, material used to form the hollow duct 230 may be compatible with high temperature operation and/or corrosive environment. For example, the hollow duct 230 may be produced using a high-temperature alloy material, such as a Ni-Cr alloy material (e.g., Hastelloy, Iconel 617, and so forth). In some embodiments, the hollow duct 230 may include one or more protective layers that line(s) an inner and/or outer surface the hollow duct 230. Such protective layer(s) may have a thickness of at least 50 micrometers, or more. By way of example, a protective layer may include as a Ni layer, an alumina layer, and so forth.

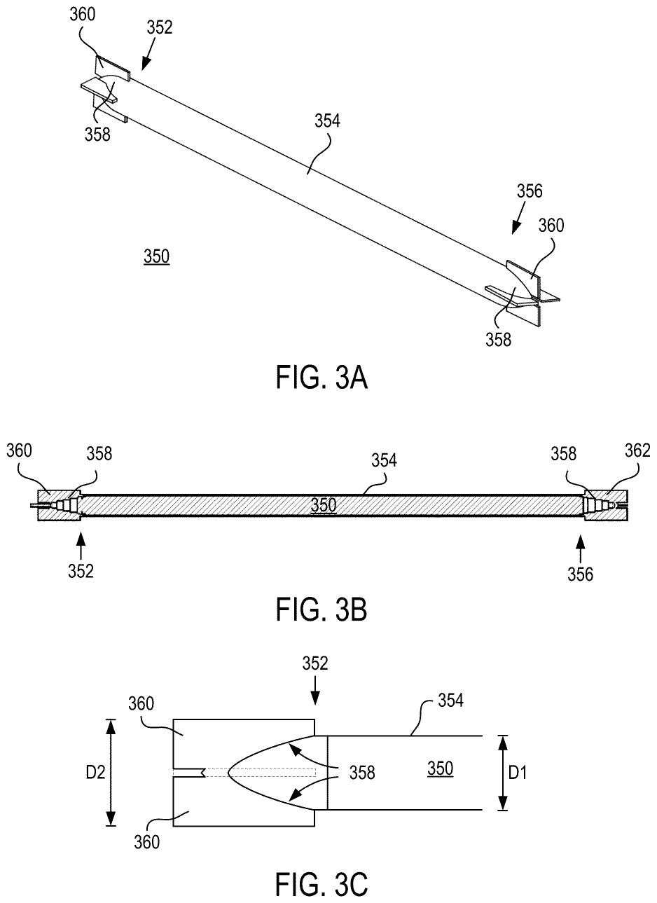

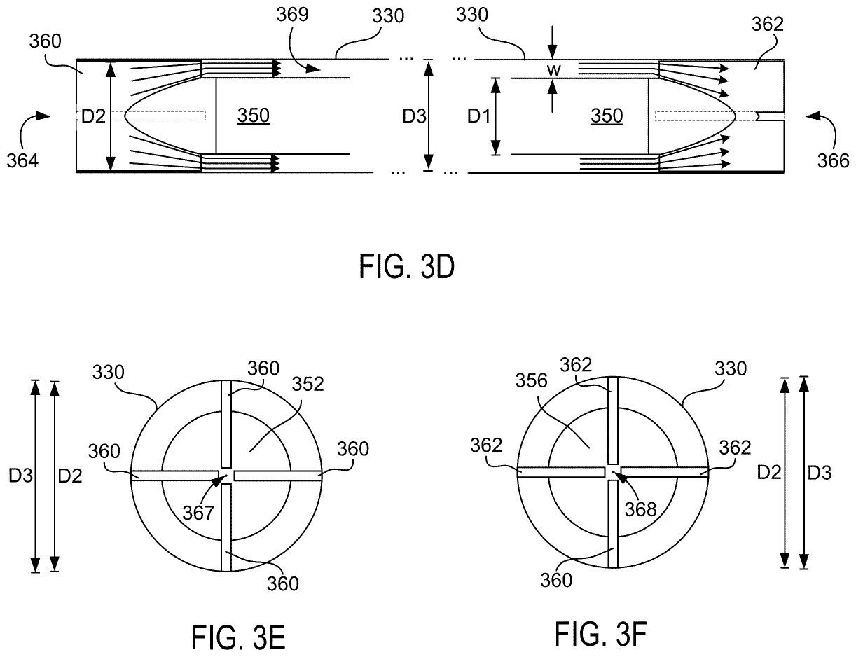

Referring particularly to FIGS. 3A-3F, one embodiment of a core 350, in accordance with aspects of the present disclosure, is illustrated. Referring particular to FIGS. 3A and 3B, the core 350 may include a first core end 352, a core body 354, and a second core end 356. The first core end 352, the second core end 356, or both may be integrated with or connected to the core body 354 in any number of ways, such as using fasteners, interference fitting, forming, welding, and so forth. In some embodiments, an outer diameter D1 of the first core end 352 and the second core end 356 of the core 350 may include a taper 358, as illustrated in FIG. 3C. In some embodiments, the taper 358 may be configured to prevent or minimize turbulent flow movement of conducting fluid. As illustrated in FIG. 3A, the core 350 may be in the form of a torpedo core.

In some embodiments, the core 350 may include a first set of fins 360 at the first core end 352 and a second set of fins 362 at the second core end 356. The first set of fins 360, may be attached to, or may extend from, the first core end 352, and the second set of fins 362, may be attached to, or may extend from, the second core end 356. As shown in FIG. 3C, the first set of fins 360, and the second set of fins 362, may extend radially outward to an outer diameter D2. While FIGS. 3A-3F show the first set of fins 360 and the second set of fins 362 to each include 4 fins, fewer or more fins may be possible.

In some embodiments, an interior of the core 350 includes a solid rod. In other embodiments, the interior of the core 350 includes a tube. In yet other embodiments, the interior of the core 350 includes a radially laminated rod or a radially laminated tube. The interior of the core 350 may include a magnetic material, although other materials. For instance, in some embodiments, the interior of the core 350 may include a magnetic rod or magnetic tube made from magnetic material. In one non-limiting example, the magnetic material may include a Fe-Co-V alloy material. In particular, utilizing a magnetic material in the interior of the core 350 may help direct or control a component of magnetic field (e.g., a radial component) generated by a coil assembly, as described herein. For instance, by way of structure and/or magnetization of magnetic material in the interior of the core 350, magnetic field generated by one or more coil units in the coil assembly by may be directed radially at one or more point on the outer diameter of the core 350, and help close a magnetic circuit for the magnetic field.

In some implementations, the core 350 may be positioned inside a hollow duct 330, as illustrated in FIGS. 3D to 3F. When positioned inside the hollow duct 330, the first set of fins 360 and the second set of fins 362 of the core 350 may be used align the core 350 inside the hollow duct 330. To this end, each fin of the first set of fins 360 and the second set of fins 362 may extend radially to an outer diameter D2 that is close to an inner diameter D3 of the hollow duct 330, as shown in FIG. 3D. For instance, in some embodiments, a difference between the outer diameter D2 and the inner diameter D3 of the hollow duct 330 may be within a clearance sufficient for inserting the core 350 inside the hollow duct 330, as well as maintaining a tight or interference fit between the hollow duct 330 and the core 350. For example, a difference between the outer diameter D2 and inner diameter D3 may be approximately 0.01″, or less.

When assembled, the hollow duct 330 and core 350 form a conducting fluid pathway that may carry a conducting fluid therethrough. For instance, in some applications, the conducting fluid may include a fluid at a high temperature, such as a molten salt, a liquid metal, and so forth. The conducting fluid pathway produced by the hollow duct 330 and core 350 may extend from an inlet 364 at the first core end 352 of the core 350 to an outlet 366 at the second core end 356 of the core 350, as illustrated in FIG. 3D. In some embodiments, the inlet 364 may include an inlet nozzle 367 produced by the first set of fins 360, as seen in FIG. 3E. Similarly, the outlet 366 may include an outlet nozzle 368 produced by the second set of fins 362, as seen in FIG. 3F. As appreciated from FIGS. 3E and 3F, the inlet 364 may include other openings produced by the first set of fins 360, and the outlet 366 may include other openings produced by the second set of fins 362. In some embodiments, at least a portion of the conducting fluid pathway includes an annular channel 369 with a width w defined by a difference between the outer diameter D1 of the core 350 and the inner diameter D3 of the hollow duct 330, as shown in FIG. 3D.

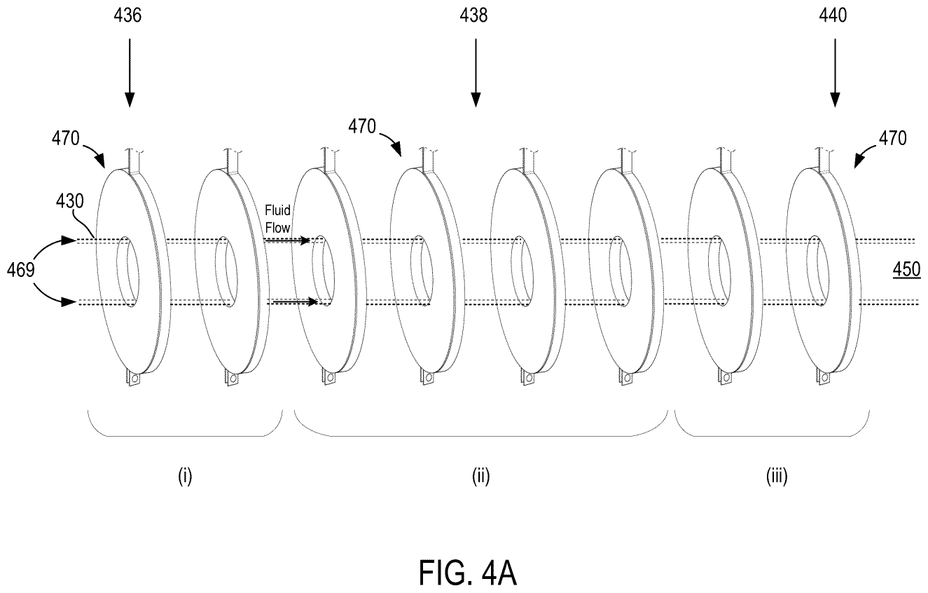

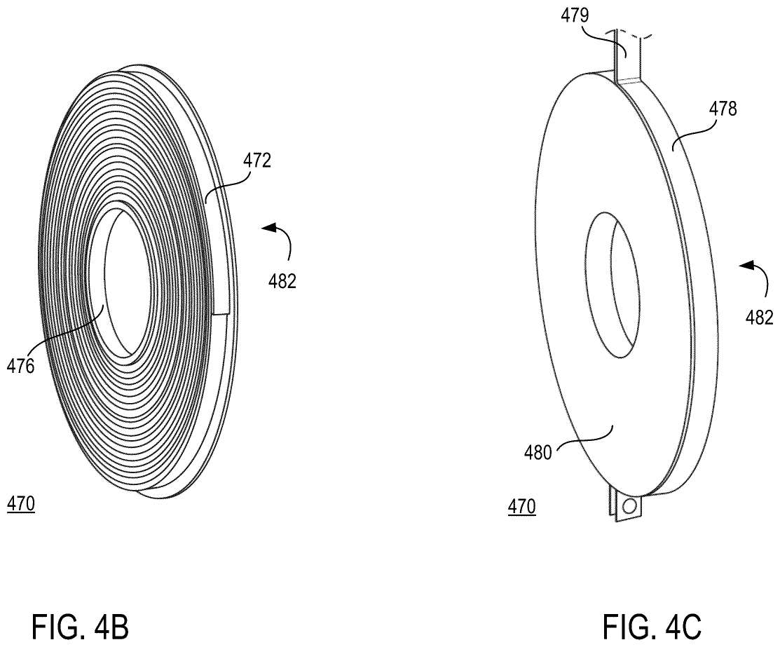

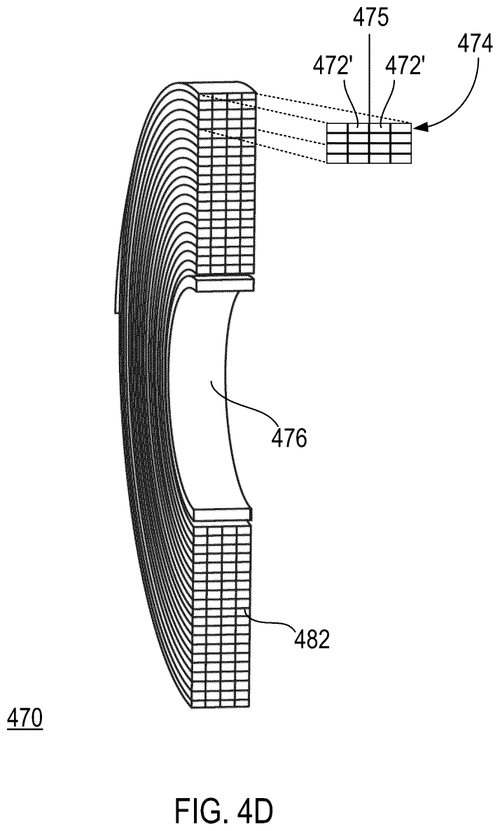

Turning now to FIGS. 4A to 4D, an example of a coil assembly 17, in accordance with aspects of the present disclosure, is illustrated. As shown, in some embodiments, the coil assembly 17 may include a number of coil units 470, where a coil unit 470 may be arranged about a hollow duct 430 and core 450, as described with reference to FIGS. 2A-2B, and 3A-3F.

In some embodiments, a coil unit 470 of the coil assembly 17 may include a winding of a conductive strip 472 (FIG. 4B). The winding of the conductive strip 472 may have any number of turns, such as 80 turns, or less, or more. To prevent electrical shorting upon winding, the conductive strip 472 may include one or more layer of insulating material (e.g., alumina). In some embodiments, a coil unit 470 may include a conductive matrix 474 that includes a number of conductive strips 472′ arranged in the array (FIG. 4D). Conductive strips 472′ in the conductive matrix 474 that are adjacent to one another may be separated by an insulating barrier 475 to prevent electrical shorting, as illustrated in FIG. 4D. In addition, the conductive matrix 474 may also include one or more layer of insulating material coating the conductive matrix 474 to prevent electrical shorting upon winding of the conductive matrix 474.

The conductive strip 472 or conductive matrix 474 may be wound about a stator ring 476, as illustrated in FIGS. 4B and 4D. In some embodiments, the stator ring 476 may have an inner diameter that corresponds to an outer diameter of the hollow duct 430, as shown in FIG. 4A. The stator ring 476 may be made using any material, such as calcium silicate material. In some applications, the stator ring 476 may help control overheating/stress damage to the coil unit 470.

In some embodiments, the coil unit 470 may also include a first disk 480 on a first side of the coil unit 470 and a second disk 482 and the second side of the coil unit 470. The first disk 480 may be attached or attachable to the first side of the coil unit 470. Similarly, the second disk 482 may be attached or attachable to the second side of the coil unit 470. For example, the first disk 480 and the second disk 482 may be attached to the stator ring 476 via tight or interference fit, or other method of attachment. The first disk 480, the second disk 482, or both, may be configured provide support, protection, and/or electrical isolation for the conductive strip 472 or the conductive matrix 474 wound therebetween. For instance, the first disk 480, and the second disk 482 may include an insulating material. In some embodiments, the first disk 480 and/or second disk 482 may include an access (e.g., an opening therein), allowing for electrical connection to the conductive strip 472, conductive matrix 474, or portion thereof, on the inner diameter of the coil unit 470.

The coil units 470 in the coil assembly 17 may be selectively operable and/or configured to generate and control magnetic field generated in or about an annular channel 469 produced by the hollow duct 430 and core 450, as shown in FIG. 4A. For instance, in embodiments, the coil assembly 17 may include a first set (i) of coil units 470, a second set (ii) of coil units 470, and a third set (iii) of coil units 470, as illustrated in FIG. 4A. As shown, the first set (i) of coil units 470 may be arranged near or about an inlet portion 436 of the hollow duct 430. The second set (ii) of coil units 470 may be arranged near or about a central portion 438 of the hollow duct 430, and the third set (iii) of coil units 470 may be arranged near or about the outlet portion 440 of the hollow duct 430.

Configuration and/or operation of the first set (i), second set (ii), and/or third set (iii) of coil units 470 may vary. For instance, a winding of conductive strips 472 in respective set of coil units 470 may vary. For example, in some embodiments, a winding of conductive strips 472 in the first set (i) of coil units 470 and in the third set (iii) of coil units 470 may be less (i.e., fewer turns) than the winding of conductive strips 472 in the second set (ii) of coil units 470. Further, in some embodiments, a winding of conductive strips 472 in the first set (i) of coil units 470 and in the third set (iii) of coil units 470 may decrease in a direction away from the central portion 438 of the hollow duct 430. Such variation in winding may be used to generate magnetic field gradients that may help control a profile of magnetic field (e.g., longitudinal magnetic field values, radial magnetic field values, and so forth) in the annular channel 469, and particularly magnetic field near the inlet portion 436 and the outlet portion 440 of the hollow duct 430.

Coil units 470 in the coil assembly 17 may be individually and/or collectively connected or connectable to one or more power source (e.g., a voltage source, a current source, and so forth) that may supply power for energizing the coil units 470 and generating a varying magnetic field in the annular channel 469. In some embodiments, the one or more power source may provide power in various phases to the coil units 470. In some implementations, coil units 470 in the first set (i) of coil units 470, the second set (ii) of coil units 470, and the third set (iii) of coil units 470 may be connected or connectable and operated in a three-phase configuration. For instance, the coil units 470 may be connected and operated using an AA ZZ BB XX CC YY sequence, where A, B, C represent a balanced three-phase configuration, and X, Y, Z, represent an opposite phase. For example, for phases A: 0°, B: 120°and C: 240°, phases may be X: 180°, Y: 300°and Z: 60°.

Responsive to the varying magnetic field generated by coil units 470 in the coil assembly 17, a pressure variation may be generated in a conducting fluid present in or flowing through the annular channel 469. Specifically, a body force may be produced on the conducting fluid via interaction between electric current and magnetic field in the conducting fluid. The body force may produce a pressure rise in the conducting fluid. The pressure rise may then drive a movement of the conducting fluid through the annular channel 469, thereby generating a pumping of the conducting fluid.

While FIG. 4A illustrates one example of a coil assembly 17, various modifications may be possible. For instance, the coil assembly 17 may include more or fewer coil units 470. More particularly, fewer or more coil units 470 may be included in the first set (i) of coil units 470, the second set (ii) of coil units 470, and the third set (iii) of coil units 470, or in a combination thereof.

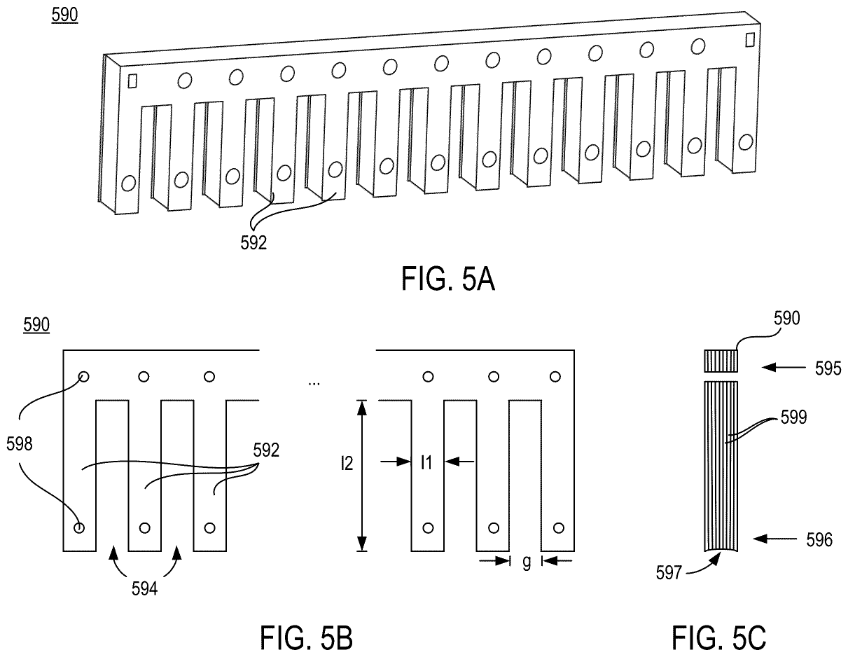

As described, the electromagnetic pump 10 includes a stator assembly 19 with a number of stator units 190. As illustrated in FIGS. 5A and 5B, in some embodiments, a stator unit 590 may include a number of dividers 592 of with lateral dimension 11 and longitudinal dimension 12. The dividers 592 may be separated by gaps 594 with lateral dimension g. Each gap 594 of the stator unit 590 may be configured to receive a section of a coil unit in a coil assembly, for instance, as described with reference to FIGS. 4A-4D. In particular, a coil unit 470 may be positioned in a gap 594 between the dividers 592, for instance, in a tight or interference fit (e.g., leaving a space of approximately 0.01″, or less). As illustrated in FIG. 5C, a divider 592 of the stator unit 590 extends from an upper portion 595 to a lower portion 596, where the lower portion 596 may include a curved portion 597, allowing the stator unit 590 to be positioned on an outer diameter of a hollow duct, for instance, as described with reference to FIGS. 2A-2B. In some embodiments, a curvature of the curved portion 597 substantially matches the curvature of the hollow duct on the outer diameter. In some embodiments, a stator assembly may include 4 stator units 590, positioned every 90 degrees on a circumference of a hollow duct, as described. In yet other embodiments, a stator assembly may include 6 stator units 590, positioned every 60 degrees on a circumference of a hollow duct.

In some embodiments, the stator unit 590 may be attached or attachable to a support structure, for instance, as described with reference to FIGS. 1A and 1B. To this end, the stator unit 590 may include a number of openings 598 for receiving a number of fasteners, as shown in FIGS. 5A and 5B.

In some embodiments, the stator unit 590 may be configured to direct a time-varying magnetic field, generated by one or more coil units 470, in a direction perpendicular to the direction of flow of the conducting fluid, as shown in FIG. 3D, for example. To this end, a structure and/or material of the stator unit 590 may be configured to control a direction of a time-varying magnetic field. For example, in some embodiments, the stator unit 590 may include a number of stator sheets 599, as illustrated in FIG. 5C. In some embodiments, stator sheets 599 in a stator unit 590 may be separated by an insulating material or may be laminated to form laminated sheets. The stator sheets 599 may extend radially as shown in FIG. 5C. In some embodiments, the stator sheets 599 may include a magnetic material. By way of example, the stator unit 590 may include a Ni-Cr-Co-Mo alloy material or a Fe-Si Steel material. The stator sheets 599 and/or magnetic material therein may direct magnetic field generated by one or more coil units of the coil assembly radially (i.e., along a length of the stator sheets 599 shown in FIG. 5C), thereby helping to close a magnetic circuit for the magnetic field via a core, as described.

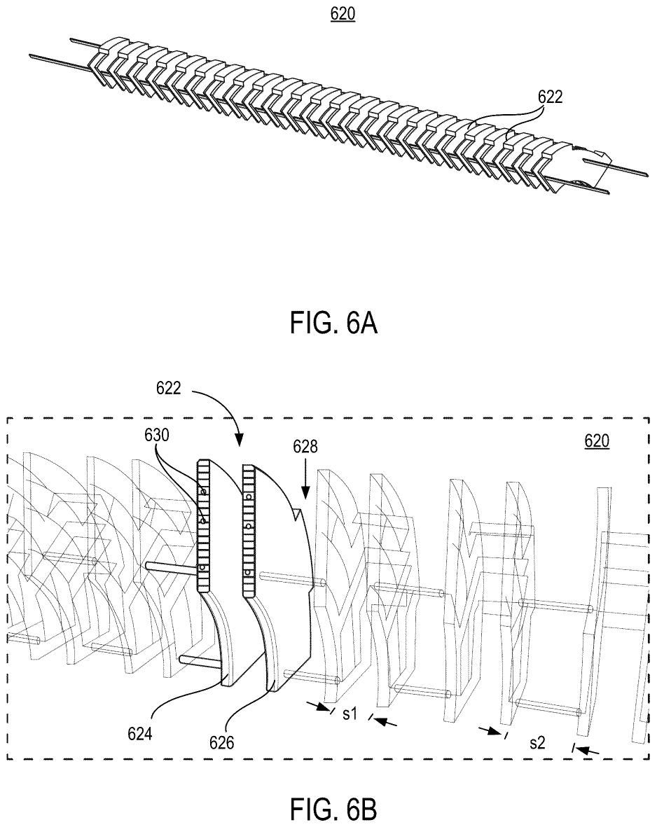

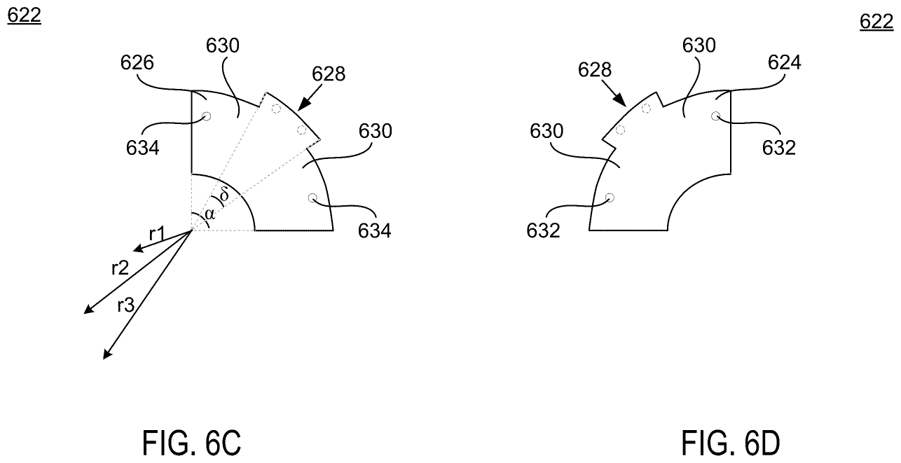

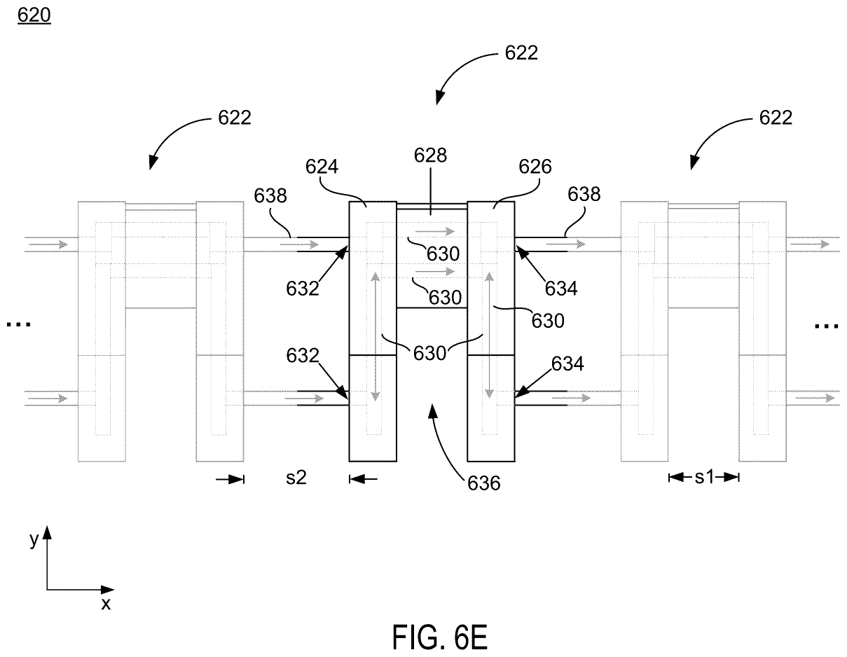

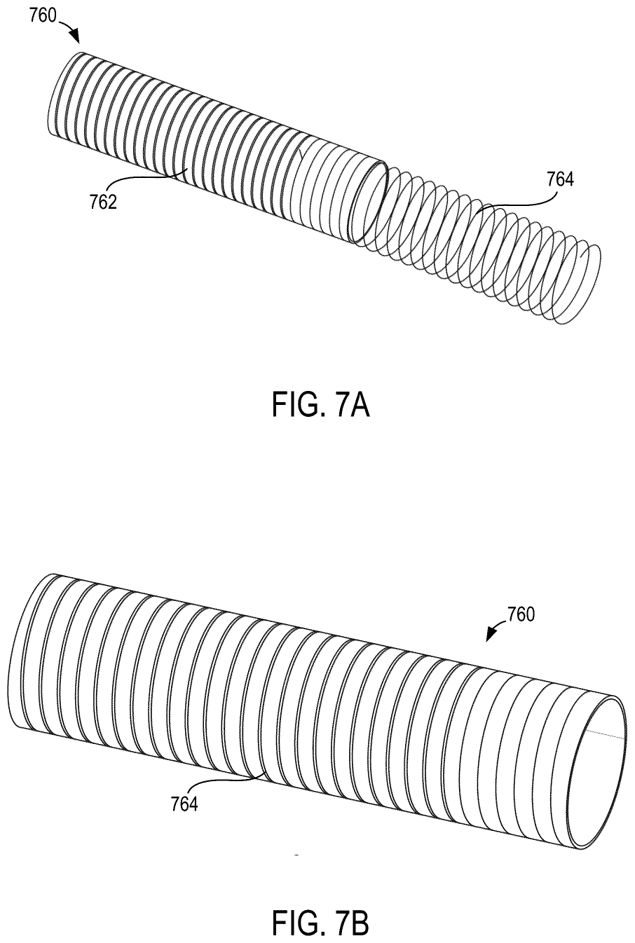

As described, an electromagnetic pump may be operated at high temperatures. Hence, in some embodiments, a cooling system may be desirable to control temperature in the electromagnetic pump. Turning to FIGS. 6A-6E, an example of a cooling stack 620 of a cooling system, in accordance with aspects of the present disclosure, is illustrated. The cooling stack 620 may include a number of cooling units 622 arranged in sequence (e.g., along a longitudinal dimension of the electromagnetic pump) and fluidly connected to one another, as shown in FIGS. 6B and 6E. In some embodiments, a cooling unit 622 may include a first cooling plate 624, a second cooling plate 626 parallel to the first cooling plate 624 and spaced from the first cooling plate 624 by a first separation s1, and at least one connector plate 628 connecting the first cooling plate 624 and the second cooling plate 626. Cooling units 622 in the cooling stack 620 may be spaced by a second separation s2, as shown in FIG. 6B.

As illustrated in FIGS. 6B-6E, the first cooling plate 624, the second cooling plate 626, and connector plate(s) 628 may include a network of microchannels 630 formed therein. In some non-limiting examples, one or more of the microchannels 630 may have a cross-sectional area between approximately 1 micrometer and approximately 1000 micrometers. The microchannels 630 may carry a cooling fluid entering the cooling unit 622, for instance, through at least one cooling unit input 632 on the first cooling plate 624, and exiting the cooling unit 622 through at least one cooling unit output 634 on the second cooling plate 626. As illustrated in FIG. 6E, in some embodiments, one or more microchannels 630 formed in the first cooling plate 626 may connect to one or more microchannels 630 formed in the second cooling plate 626 via one or more microchannels 630 formed in the connector plate(s) 628.

In some embodiments, as illustrated in FIGS. 6C and 6D, the first cooling plate 624 and the second cooling plate 626 may include an annular sector plate defined by a first radius r1, a second radius r2, and a first sector angle α. In one non-limiting example, the first sector angle a is approximately 90 degrees, thereby allowing the first cooling plate 624 and second cooling plate 626 to provide cooling to approximately one quarter of an annular coil unit. In some embodiments, as illustrated, a connector plate 628 may include an annular portion defined by the second radius 12, a third radius r3, and a second sector angle δ. In one non-limiting example, the second sector angle δ is between approximately 15 degrees and approximately 45 degrees.

In some embodiments, at least some microchannels 630 formed in the first cooling plate 624 and the second cooling plate 626 extend substantially in the plane of the first cooling plate 624 and second cooling plate 626, along a transverse direction of an electromagnetic pump (e.g., y-axis in FIG. 6E). In some embodiments, at least some microchannels 630 formed in the connector plate(s) 628 extend substantially out of plane of the first cooling plate 624 and second cooling plate 626, along a longitudinal direction of the electromagnetic pump (e.g., X-axis shown in FIG. 6E).

In some embodiments, the first cooling plate 624, the connector plate(s) 628, and the second cooling plate 626 of the cooling unit 622 form a space 636 that is shaped and dimensioned to receive a section of a coil unit of the electromagnetic pump, such as a coil unit 470 described with reference to FIGS. 4A-4D. For instance, the first separation s1 between the first cooling plate 624 and the second cooling plate 626 may correspond to a width of a coil unit, such that the coil unit may be positioned between the first cooling plate 624 and the second cooling plate 626 to provide cooling to the coil unit.

As illustrated in FIGS. 6A and 6E, cooling units 622 in a cooling stack 620 may be fluidly connected or connectable using tubing 638. For instance, tubing 638 may be attached using various techniques (e.g., brazing, soldering, welding, bonding, and so forth). The tubing 638 may then be connected or connectable to one or more source of cooling fluid in a cooling system.

Cooling units 622 in a cooling stack 620 may include or be formed using various materials. For instance, in some embodiments, a cooling unit 622 may include a material that can achieve electrical insulation and/or high thermal conductivity. For example, a cooling stack 620 may include Ceralloy 147-31N. In some implementations, cooling units 622 in a cooling stack 620 may be formed using an additive manufacturing technique (e.g., 3D printing).

While FIGS. 6A-6E show example embodiments of a cooling stack 620 in a cooling system, variations and modifications may be possible. For instance, a shape, dimension, number, and/or arrangement of one or more cooling unit 622 in a cooling stack 620, as well as cooling stacks 620 in a cooling system, may vary. For example, in some embodiments, the microchannels 630 in a cooling unit 622 may be arranged in a periodic pattern, an aperiodic pattern, or a combination thereof. In some embodiments, one or more cooling unit inputs 632 on the first cooling plate 624 may be connected to the one or more cooling unit outputs 634 on the second cooling plate 626 via microchannels 630 arranged in parallel, in series, or a combination thereof, establishing one or more fluid pathways between each cooling unit input 630 and cooling unit output 634.

As appreciated from FIGS. 6A-6E, in some embodiments, a cooling system may include four cooling stacks 620, each cooling stack 620 capable of cooling a portion of coil units in a coil assembly. In other embodiments, a cooling system may include fewer or more cooling stacks 620. For instance, in some embodiments, a cooling system may include two cooling stacks 620, each cooling stack 630 including cooling units 620

In some embodiments, a cooling system, in accordance with aspects of the present disclosure, may include a cooling sleeve 760, as illustrated in FIGS. 7A and 7B. The cooling sleeve 760 may include a helical channel 762 extending along a length of the cooling sleeve 760. As shown, the helical channel 762 may receive a helical cooling coil 764 that may carry a cooling fluid to cool the cooling sleeve 760, and components arranged therein. The cooling sleeve 760 may be configured, for example, by way of an inner diameter, to fit around one or more components, such as stator units 590 as described with reference to FIGS. 5A-5C, and coil units 470, as described with reference to FIGS. 4A-4D.

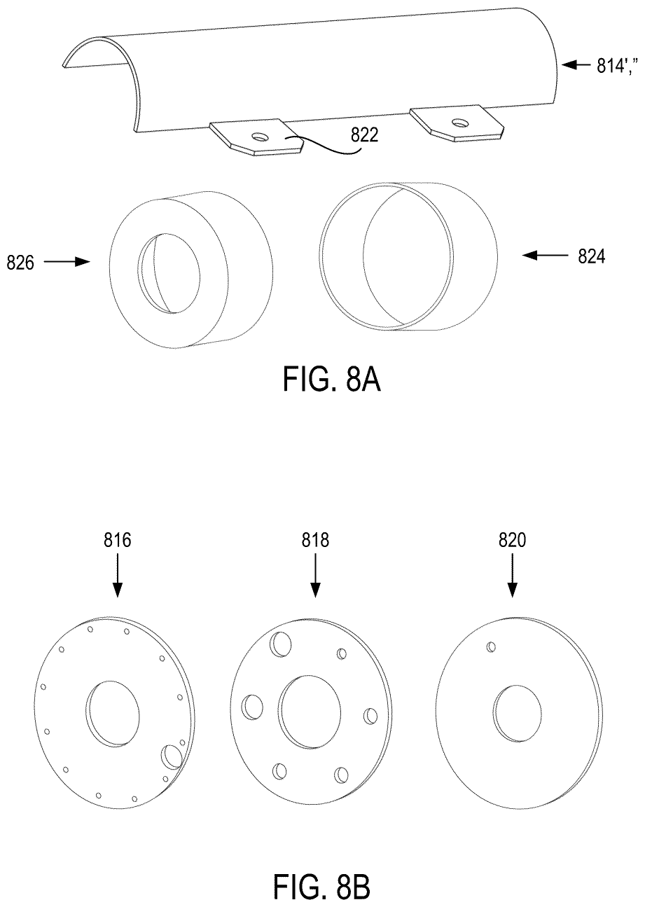

As described, an electromagnetic pump, in accordance with aspects of the present disclosure, may include a support structure with various components. The components of the support structure may be connected using various methods, such as welding, brazing, fastening, and so forth. In some embodiments, illustrated in FIGS. 8A and 8B, the support structure may include a first shell 814′ and a second shell 814″, a first end plate 816, a second end plate 818, a third plate 820. As illustrated, the first shell 814′ and the second shell 814″ may include one or more tabs 822 with openings extending therefrom, allowing for the first shell 814′ and the second shell 814″ to be fastened together, e.g., using bolts, screws, or other fasteners. Also, the first end plate 816, a second end plate 818, a third plate 820, may include various openings, for instance, to provide access for the hollow duct, as well as various sensors, instrumentation, fasteners, filler, and so forth. The support structure may also include at least one end collar 824 and at least one cover 826, shown in FIG. 8A. Together, components of the support structure can provide structural rigidity, access, and/or protection of components of the electromagnetic pump.

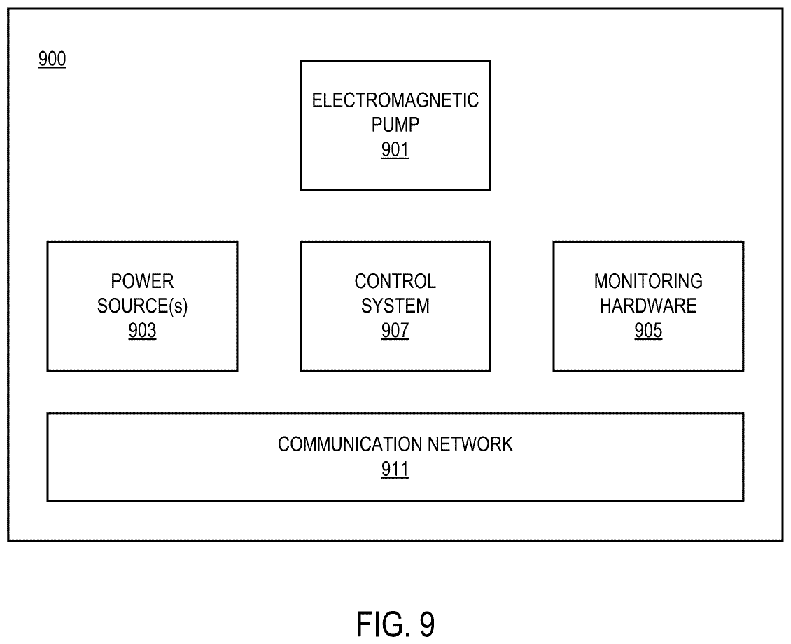

Turning to FIG. 9, an example of an electromagnetic pump system 900, according to aspects of the present disclosure, is illustrated. In some embodiments, the electromagnetic pump system 900 may include an electromagnetic pump 901, one or more power sources 903 to power the electromagnetic pump 901, and monitoring hardware 905 to monitor operation of the electromagnetic pump 901.

The electromagnetic pump 901 may be configured to move conducting fluid, in accordance with aspects of the present disclosure. For instance, in some embodiments, the electromagnetic pump may include a hollow duct extending from a first duct end to a second duct end, where the hollow duct includes an inlet portion, a central portion, and an outlet portion. The electromagnetic pump may also include a core positioned inside the hollow duct that extends from a first core end to a second core end, where the hollow duct and the core form an annular channel for carrying the conducting fluid.

In some embodiments, the electromagnetic pump may include a coil assembly with a plurality of coil units. As described, in some embodiments, the coil assembly may include a first set of coil units arranged about the inlet portion of the hollow duct, a second set of coil units arranged about the center portion of the hollow duct, and a third set of coil units arranged about the outlet portion of the hollow duct. The coil units may be operable to generate a time-varying magnetic field that can move the conducting fluid through the annular channel.

In some embodiments, the electromagnetic pump may include a stator assembly with a plurality of stator units. As described, a stator unit may be configured to receive various coil units in a coil assembly. For instance, the stator unit may include a number of gaps, each receiving a section of a coil unit of the first set of coil units, the second set of coil units, and the third set of coil units, as described. In sone embodiments, a stator unit may be configured to direct magnetic field generated by coil units positioned in the gaps of the stator unit. In particular, the stator unit may be configured to direct magnetic field radially along a direction perpendicular to the direction of flow of the conducting fluid, as described.

In some embodiments, the electromagnetic pump 901 may include a cooling system with a number of cooling stacks, where each stack includes a number of cooling units arranged longitudinally in sequence, and fluidly connected to one another, as described. In some embodiments, a cooling unit may include a first cooling plate with at least one cooling unit input, a second cooling plate parallel to the first cooling plate that includes at least one cooling unit output. The cooling unit may also include at least one connector plate connecting the first cooling plate and the second cooling plate, and a network of microchannels formed in the first cooling plate, the second cooling plate, and the connector plate(s), where the network of microchannels connects the cooling unit input(s) on the first cooling plate to the cooling unit output(s) on the second cooling plate to form one or more fluid pathways for cooling fluid to flow therethrough. In some embodiments, the 901 electromagnetic pump and/or cooling system may include a cooling sleeve with a helical channel, where the helical channel may be configured to receive a cooling coil for carrying cooling fluid.

The power source(s) 903 may include various systems, devices, components, hardware, and so forth, which may be configured to controllably supply power for energizing coil units of the coil assembly of the electromagnetic pump 901. In some embodiments, the power source(s) 903 may be configured to provide one or more time-varying power signal with one or more predefined phase. In this manner, the power source(s) 903 may controllably generate a time-varying magnetic field in or about the annular channel of the electromagnetic pump 901 to pump conducting fluid in the annular channel. By way of example, the power source(s) 903 may include one or more voltage source, one or more current source, or a combination thereof.

The monitoring hardware 905 may include various systems, devices, components, hardware, and so forth, configured to monitor operation of the electromagnetic pump 901. For instance, the monitoring hardware 905 may include various digitizers, filters, amplifiers, integrators, differentiators, data loggers/recorders, data acquisition cards, and so forth, capable of receiving, as well as conditioning, signals captured by one or more sensors positioned on or about the electromagnetic pump 901.

For example, in some embodiments, the monitoring hardware 905 may receive temperature readings from one or more temperature sensors (e.g., thermocouple sensor(s)) arranged to capture temperature signals of various components on the electromagnetic pump 901, such as the coil assembly, stator assembly, and so forth. In some embodiments, the monitoring hardware 905 may receive pressure readings from one or more pressure sensors arranged to capture pressure signals of various components on the electromagnetic pump 901. For instance, in one example, the pressure sensor(s) may receive pressure readings corresponding to conducting fluid entering and/or exiting the electromagnetic pump 901. In another example, the pressure sensor(s) may receive pressure readings corresponding to cooling fluid in the cooling system of the electromagnetic pump 901. In some embodiments, the monitoring hardware 905 may receive current readings from one or more current sensors arranged to capture current signals corresponding to current flowing in one or more coil unit of the coil assembly of the electromagnetic pump 901. In some embodiments, the monitoring hardware 905 may receive magnetic field readings from one or more magnetic field sensors (e.g., Hall probe(s)) arranged to capture magnetic field signals corresponding to time-varying magnetic field generated by one or more coil units of the coil assembly of the electromagnetic pump 901. In some embodiments, the monitoring hardware 905 may receive flow readings from one or more flow sensors (e.g., electromagnetic flow meter) arranged to capture flow signals corresponding to conducting fluid pumped by the electromagnetic pump 901. Also, in some embodiments, the monitoring hardware 905 may receive flow readings from one or more flow sensors configured to capture flow signals corresponding to cooling fluid circulated by a source of cooling fluid (e.g., pump).

In some embodiments, the monitoring hardware 905 may also include or communicate with various systems, devices, components, hardware, and so forth, configured to monitor operation of other systems, devices, and equipment, such as systems, devices, and equipment associated with a reactor.

Referring again to FIG. 9, in some, the electromagnetic pump system 900 may also include a control system 907, as shown. The control system 907 may include various systems, devices, components, hardware, and so forth, configured to control operation of the electromagnetic pump 901 and/or various components therein. For example, the control system 907 may include a workstation, personal computer, laptop, tablet, smartphone, microcontroller, and so forth.

In some embodiments, the control system 907 may include one or more processor configured, via programmed and/or hardwired instructions, for carrying out various steps to control operation of the electromagnetic pump 901 and/or various components therein. As such, the control system 907 may be configured to receive and/or process various data and information, as well as generate and provide various data, information, and signals. For instance, the processor(s) may be configured to generate, or direct another component on or connected to the control system 907 (e.g., a signal generator) to generate, one or more control signal, such as a voltage signal, current signal, optical signal, and so forth. In one example, one or more power control signals may be generated to select one or more characteristics of a power signal, such as amplitude, phase, frequency, and so forth. In some implementations, power control signal(s) may be generated based on a predetermined flow of a conducting fluid through a reactor, or based on a predetermined temperature of a reactor, or based on a predetermined cooling rate of a reactor, and so forth. Responsive to the power control signal(s), the power source(s) 903 may output one or more power signals with the selected characteristic(s). In another example, one or more cooling control signals may be generated to control temperature on the electromagnetic pump 901. Responsive to the cooling control signal(s), a pump connected or connectable to the control system 907) may control (e.g., increase, decrease, etc.) flow of cooling fluid in the cooling system of the electromagnetic pump 901, or in a component therein, such as the cooling stack(s), helical coil, and so forth, as described.

The control system 907 may include various components and/or hardware for receiving and/or transmitting data, information, signals, and so forth. For example, the control system 907 may include an interface with various input and output connectors. In some embodiments, the control system 907 may be configured to generate and provide a report to a user. Hence, in some embodiments, the control system 907 may include one or more display for providing a report to the user, for instance, via one or more graphical user interface (GUI). The report may be in any form (e.g., graphics, graph, table, image, listing, and so, forth) and include any signals, data, and information. For example, the report may display received and/or conditioned signals obtained by the monitoring hardware 905.

Various components of the electromagnetic pump system 900 may be connected or connectable by way of a communication network 911. The communication network 911 may include various components, hardware, wiring, and so forth, for facilitating exchange of signals, data, and information between the components of the electromagnetic pump system 900, via wired and/or wireless communication.

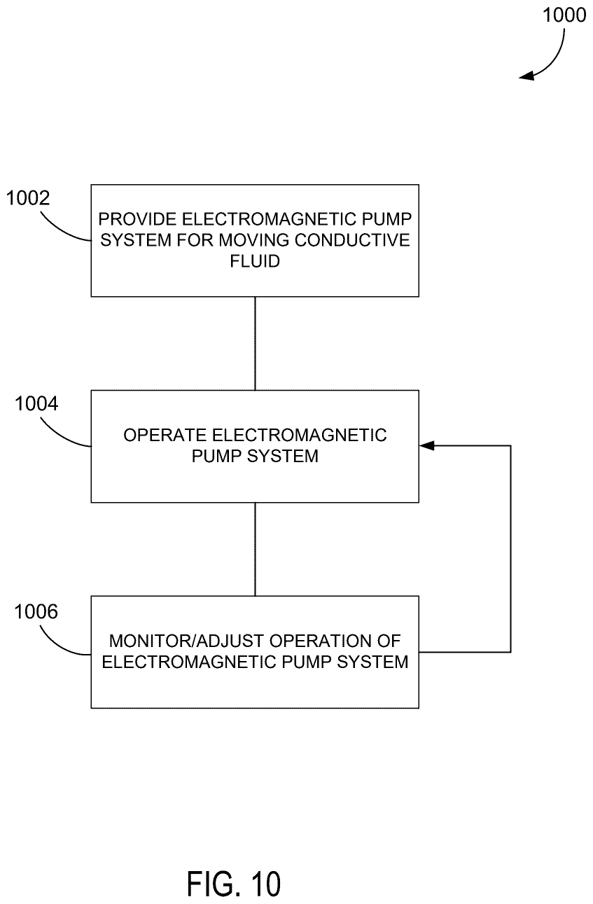

Turning now to FIG. 10 a flowchart setting forth steps of a process 1000 for operating an electromagnetic pump system, according to aspects of the present disclosure, is illustrated. Steps of the process 1000 may be carried out using any suitable devices, tools, hardware, systems, and so forth. Although the process 1000 is illustrated and described as a sequence of steps, it is contemplated that the steps may be produced in any order or combination, need not include all illustrated steps, and may include additional steps.

The process 1000 may begin at process block 1002 with providing an electromagnetic pump system for moving conductive fluid, in accordance with aspects of the present disclosure. Alternatively, or additionally, the electromagnetic pump system, and various components therein, may be installed or assembled at process block 1002. For instance, in some implementations, an electromagnetic pump, as described, may be assembled by attaching or connecting cooling stacks to a coil assembly, where cooling units of the cooling stacks may be inserted between coil units, for instance, in a tight or interference fit. The cooling stacks and coil assembly may be positioned about a hollow duct, where tubing from the cooling stacks may be inserted through openings in a first end plate. A stator assembly may be attached, whereby a stator unit is fixed using one or more fastener. In some implementations, thermocouple bars may be inserted through openings in the first end plate. A helical coil may be arranged in the helical channel of a cooling sleeve, and the cooling sleeve may be positioned about over the stator assembly, coil assembly, and cooling stacks. A second end plate may be positioned on the electromagnetic pump, whereby tubing of the cooling stacks is inserted through openings in the second end plate. The stator assembly may be fastened to the second end plate using various fasteners. An end collar may be arranged on the second duct end, and secured in place (e.g., via welding). The core may be inserted into the hollow duct, and an end cover may then be attached to the second plate. Shell components may be arranged over the electromagnetic pump, and secured in place (e.g., using fasteners, welding, and so forth). In some implementations, an internal space of the electromagnetic pump, such as the space between the shell(s), end plate(s), hollow duct, stator units, and coil units, may be filled with a filler. In some embodiments, the internal space may be filled with a material that is electrically insulating. Alternatively, or additionally, the internal space may be filled with a material that is thermally conductive. For example, the filler may include a Ceralloy powder. Tubing of the cooling system may be connected to a source of cooling fluid. The electromagnetic pump may be connected to one or more sources of conductive fluid, via various conduits transporting the conductive fluid. Also, one or more sources of power may be connected to the various coil units in the coil assembly.

Once provided, assembled, and/or installed, the electromagnetic pump system may be operated, as indicated by process block 1004. Operation of the electromagnetic pump system may include a number of steps, including energizing various coil units on the coil assembly to generate a time-varying magnetic field that can move the conducting fluid through the annular channel, as discussed. Operation of the electromagnetic pump system may also include establishing flow of cooling fluid in a cooling system, according to embodiments described herein.

Aspects of operation of the electromagnetic pump system may be monitored, as indicated by process block 1006. To this end, various readings may be obtained from various sensors, such as temperature readings, pressure readings, current readings, magnetic field readings, flow readings, and so forth, to monitor operation of the electromagnetic pump system, and/or components therein, as described. In some implementations, a report may be generated at process block 1006. As described, the report may be in any form and provide any information. For example, a report may be indicative of electromagnetic pump performance, pumping speed, temperature, pressure, flow, and so forth.

In some implementations, operation of the electromagnetic pump may be adjusted at process block 1006 based on various readings obtained various sensors. To this end, various control signals may be generated and provided to various devices, systems, and hardware controlling various aspects of the electromagnetic pump system. For instance, in some implementations, a control system may generate and provide various power control signals to select one or more characteristics of a power signal, such as amplitude, phase, frequency, and so forth, to coil units in a coil assembly. In other implementations, a control system may generate and provide various cooling control signals to control temperature on an electromagnetic pump, or a component therein. To this end, the cooling control signal(s) may be configured to control flow of cooling fluid through a cooling system, as described. Monitoring and/or adjustment of operation of the electromagnetic pump system may be performed continuously, intermittently, periodically, and so forth.

One or more elements or aspects or steps, or any portion(s) thereof, from one or more of any of claims herein can be combined with one or more elements or aspects or steps, or any portion(s) thereof, from one or more of any of the other claims or combinations thereof, to form one or more additional implementations and/or claims of the present disclosure.

While various examples of the present disclosure have been described above, it should be understood that they have been presented by way of example only, and not limitation. Numerous changes to the disclosed examples can be made in accordance with the disclosure herein without departing from the spirit or scope of the disclosure. Thus, the breadth and scope of the present disclosure should not be limited by any of the above-described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this disclosure belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A cooling system for an electromagnetic pump system, the cooling system comprising:
a cooling stack comprising a plurality of cooling units arranged in sequence, and configured to cool a plurality of coil units of the electromagnetic pump system, a cooling unit comprising:
a first cooling plate that comprises a cooling unit input;
a second cooling plate that is parallel to the first cooling plate, and comprises a cooling unit output;
at least one connector plate connecting the first cooling plate and the second cooling plate; and
a network of microchannels formed in the first cooling plate, the second cooling plate, and the at least one connector plate, the network of microchannels connecting the cooling unit input and the cooling unit output, and allowing a cooling fluid to flow therethrough.

2. The cooling system of claim 1, wherein the first cooling plate and the second cooling plate comprises an annular sector plate defined by a first radius, a second radius, and a first sector angle.

3. The cooling system of claim 2, wherein the first sector angle is approximately 90 degrees.

4. The cooling system of claim 2, wherein the at least one connector plate comprises an annular portion defined by the second radius, a third radius, and a second sector angle.

5. The cooling system of claim 4, wherein the second sector angle is between approximately 15 degrees and approximately 45 degrees.

6. The cooling system of claim 2, wherein the at least one connector plate extends from the second radius of the first cooling plate to the second radius of the second cooling plate along a longitudinal direction of the electromagnetic pump system.

7. The cooling system of claim 1, wherein the first cooling plate, the second cooling plate, and the at least one connector plate form a space shaped and dimensioned to receive a section of a coil unit of the electromagnetic pump system.

8. The cooling system of claim 7, wherein the first cooling plate is displaced from the second cooling plate by a first separation that corresponds to a width of the coil unit.

9. The cooling system of claim 1, wherein the plurality of cooling units in the cooling stack are fluidly connected using tubing.

10. The cooling system of claim 9, wherein the cooling system further comprises at least one source of cooling fluid connected or connectable to the cooling stack.

11. The cooling system of claim 1, wherein the cooling system further comprises a cooling sleeve comprising a helical channel configured to receive a cooling coil for carrying cooling fluid.

12. An electromagnetic pump system comprising:
an electromagnetic pump comprising:
a hollow duct extending from a first duct end to a second duct end, the hollow duct having an inlet portion, a central portion, and an outlet portion;
a core positioned inside the hollow duct that extends from a first core end to a second core end, wherein the hollow duct and the core form an annular channel for carrying a conducting fluid;
a coil assembly comprising a plurality of coil units;
a stator assembly comprising a plurality of stator units arranged about the hollow duct, the stator assembly configured to receive the plurality of coil units; and
a cooling system comprising at least one cooling stack with plurality of cooling units arranged in sequence, the at least one cooling stack arranged about the plurality of coil units and configured to cool the plurality of coil units.

13. The electromagnetic pump system of claim 12, where a cooling unit on the at least one cooling stack comprises:
a first cooling plate that comprises a cooling unit input;
a second cooling plate that is parallel to the first cooling plate, and comprises a cooling unit output;
at least one connector plate connecting the first cooling plate and the second cooling plate; and
a network of microchannels formed in the first cooling plate, the second cooling plate, and the at least one connector plate, the network of microchannels connecting the cooling unit input and the cooling unit output, and allowing a cooling fluid to flow therethrough.

14. The electromagnetic pump system of claim 13, wherein the first cooling plate and the second cooling plate comprises an annular sector plate defined by a first radius, a second radius, and a first sector angle.

15. The electromagnetic pump system of claim 14, wherein the first sector angle is approximately 90 degrees.

16. The electromagnetic pump system of claim 14, wherein the at least one connector plate comprises an annular portion defined by the second radius, a third radius, and a second sector angle.

17. The electromagnetic pump system of claim 16, wherein the second sector angle is between approximately 15 degrees and approximately 45 degrees.

18. The electromagnetic pump system of claim 14, wherein the at least one connector plate extends from the second radius of the first cooling plate to the second radius of the second cooling plate along a longitudinal direction of the electromagnetic pump.

19. The electromagnetic pump system of claim 13, wherein the first cooling plate, the second cooling plate, and the at least one connector plate of the cooling unit form a space shaped and dimensioned to receive a section of a coil unit of the electromagnetic pump, and the first cooling plate is displaced from the second cooling plate by a first separation that corresponds to a width of the coil unit.

20. The electromagnetic pump system of claim 12, wherein the cooling system further comprises a cooling sleeve comprising a helical channel configured to receive a cooling coil for carrying a cooling fluid.
